(19) United States
(12) Patent Application Publication
(10) Pub. No.: US 2026/0017294 A1
(43) Pub. Date: Jan. 15, 2026

(54) SMART CITY SERVICE METHOD, SYSTEM, AND MEDIUM BASED ON INTERNET OF THINGS LARGE MODEL

(71) Applicant: CHENGDU QINCHUAN IOT TECHNOLOGY CO., LTD., Chengdu (CN)

(72) Inventor: Hanshu SHAO, Chengdu (CN)

(73) Assignee: CHENGDU QINCHUAN IOT TECHNOLOGY CO., LTD., Chengdu (CN)

(21) Appl. No.: 19/336,609

(22) Filed: Sep. 23, 2025

(30) Foreign Application Priority Data
Sep. 3, 2025 (CN) 202511251009.4

(51) Int. Cl. G06F 16/3329; G06F 16/334; G06F 16/335; G06F 40/35; G06N 7/02; G16Y 10/60

(52) U.S. Cl. CPC G06F 16/33295; G06F 16/3344; G06F 16/335; G06F 40/35; G06N 7/02; G16Y 10/60

(57) ABSTRACT

Provided is a smart city service system based on an Internet of Things large model. The system includes a smart city user platform and a smart city service platform, the smart city service platform includes a chatbot, and the chatbot is configured to: obtain a query sent by a user through a user interface; determine, based on the query, initial service information of the query from a service information database through semantic search; determine, based on the query and modal information of the initial service information, a target service model from a user service model library; generate a response to the query based on the query, the initial service information, and an expression evaluation value through the target service model; and send the response to the smart city user platform, and output the response through the user interface.

### CROSS-REFERENCE TO RELATED APPLICATIONS

This application claims priority of Chinese Patent Application No. 202511251009.4, filed on Sep. 3, 2025, the entire contents of which are incorporated herein by reference.

### TECHNICAL FIELD

The present disclosure relates to the field of smart city services, and in particular to a smart city service method, system, and medium based on an Internet of Things large model.

### BACKGROUND

With the development of information technology, city services are accelerating their transformation toward digitalization and intelligence. The service scenarios in cities are complex and diverse, with a broad user base and significant variations in their demands. Traditional service platforms struggle to satisfy demands for personalized information services of users. In recent years, the large model technology has demonstrated a strong semantic comprehension ability and generative capacity in the field of natural language processing, which provides new possibilities for intelligent information services. In practical applications, how to carry out customized training according to different types of users (e.g., industry, occupation, age, etc.) to provide personalized information services for different user groups remains a problem to be solved urgently.

Therefore, it is necessary to provide a smart city service method and system based on an Internet of Things large model to achieve personalized information services for users and intelligent decision support.

### SUMMARY

One or more embodiments of the present disclosure provide a smart city service system based on an Internet of Things large model, the system includes a smart city user platform and a smart city service platform, the smart city service platform includes a chatbot, and the chatbot is configured to: obtain a query sent by a user through a user interface; determine, based on the query, initial service information of the query from a service information database through semantic search, the service information database being disposed in a memory of the chatbot; determine, based on the query and modal information of the initial service information, a target service model from a user service model library, the target service model being stored in the memory of the chatbot; generate a response to the query based on the query, the initial service information, and an expression evaluation value through the target service model; and send the response to the smart city user platform, and output the response through the user interface.

One or more embodiments of the present disclosure provide a smart city service method based on an Internet of Things large model, the method includes: obtaining a query sent by a user through a user interface; determining, based on the query, initial service information of the query from a service information database by semantic search, the service information database being disposed in a memory of a chatbot; determining, based on the query and modal information of the initial service information, a target service model from a user service model library, the target service model being stored within the memory of the chatbot; generating a response to the query based on the query, the initial service information, and an expression evaluation value by the target service model; and sending the response to a smart city user platform, and outputting the response through the user interface.

One or more embodiments of the present disclosure provide a non-transitory computer-readable storage medium, the non-transitory computer-readable storage medium stores computer instructions, and when a computer reads the computer instructions in the non-transitory computer-readable storage medium, the computer executes a smart city service method based on an Internet of Things large model.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram illustrating a platform structure of a smart city service system based on an Internet of Things large model according to some embodiments of the present disclosure;

FIG. 2 is a flowchart illustrating an exemplary process for determining a response according to some embodiments of the present disclosure;

FIG. 3 is a schematic diagram of a user service model according to some embodiments of the present disclosure; and

FIG. 4 is a schematic diagram illustrating a fuzzy processing model according to some embodiments of the present disclosure.

### DETAILED DESCRIPTION

In order to more clearly illustrate the technical solutions of the embodiments of the present disclosure, the accompanying drawings required to be used in the description of the embodiments will be briefly described below. Obviously, the accompanying drawings in the following description are only some examples or embodiments of the present disclosure, and it is possible for a person of ordinary skill in the art to apply the present disclosure to other similar scenarios in accordance with these drawings without creative labor. Unless obviously obtained from the context or the context illustrates otherwise, the same numeral in the drawings refers to the same structure or operation.

It should be understood that the terms “system”, “device”, “unit” and/or “module” used herein are a method for distinguishing different components, elements, parts, sections, or assemblies at different levels. However, if other words can achieve the same purpose, the aforementioned terms may be replaced by other expressions.

Flowcharts are used in the present disclosure to illustrate the operations performed by the system according to the embodiments described herein. It should be understood that the operations may not necessarily be performed in the exact sequence depicted. Instead, the operations may be performed in reverse order or concurrently. Additionally, other operations may be added to these processes, or one or more operations may be removed.

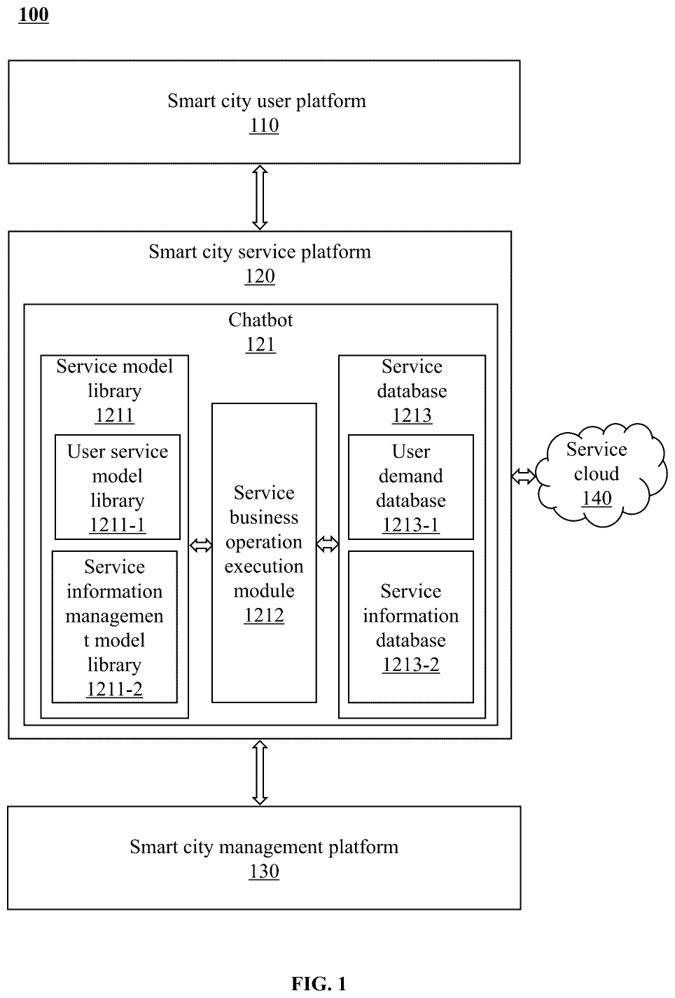

FIG. 1 is a schematic diagram illustrating a platform structure of a smart city service system based on an Internet of Things large model according to some embodiments of the present disclosure.

In some embodiments, as shown in FIG. 1, a smart city service system 100 (hereinafter referred to as a system 100) based on the Internet of Things (IOT) large model may include a smart city user platform 110, a smart city service platform 120, a smart city management platform 130, and a service cloud 140. In some embodiments, the smart city user platform 110, the smart city service platform 120, the smart city management platform 130, and the service cloud 140 may be connected to each other sequentially. The IoT large model refers to an IoT model architecture for realizing an efficient operation of large amounts of data in the system 100. In some embodiments, an artificial intelligence model (e.g., ChatGPT, Gemini, Deepseek) may be applied in the IoT model architecture for data sensing and processing.

The smart city user platform 110 refers to a platform for interacting with users. In some embodiments, the smart city user platform 110 may be configured as a server, a gateway, or the like. In some embodiments, the smart city user platform 110 further includes a local caching unit.

In some embodiments, when the smart city user platform 110 is configured as the server, the smart city user platform 110 may receive a request, a query, or the like., from a user, and the smart city user platform 110 may obtain information (e.g., user demand information, service information) from a database (e.g., a user demand database, a service information database) based on the request, the query, or the like., of the user. In some embodiments, when the smart city user platform 110 is configured as the server, the smart city user platform 110 may provide a user interface to the user to read and record user information and/or user data. In some embodiments, the smart city user platform 110 may be an edge server.

The smart city service platform 120 is configured to preprocess (e.g., clean, categorize, label, etc.) the service information and the user demand information and store preprocessed service information and user demand information into a database (e.g., a service database). In some embodiments, the smart city service platform 120 may include a server, a memory, a gateway, etc. In some embodiments, the smart city service platform 120 may further include a chatbot 121. The chatbot 121 may include a service model library 1211, a service business operation execution module 1212, and a service database 1213.

The chatbot 121 refers to a computer program capable of interacting with the user through natural language to provide automated services or entertainment functions by simulating human conversation. The chatbot 121 may understand context, learn user habits, and optimize responses through Natural Language Processing (NLP), Machine Learning (ML), and Deep Learning (DL) technologies. In some embodiments, the chatbot 121 is configured to receive a query sent by a user, generate a response to the query based on the query, and return the response to the query.

The service model library 1211 includes a user service model library 1211-1 and a service information management model library 1211-2. The user service model library 1211-1 is configured to store a trained user service model and/or a semantic feature corresponding to the user service model. The service information management model library 1211-2 is configured to store a service information management model.

In some embodiments, the user service model and the service information management model may be a machine learning model. For example, the machine learning model may include a Multilayer Perceptron (MLP), a Convolutional Neural Network (CNN), a Recurrent Neural Network (RNN), etc. In some embodiments, the user service model is configured to preprocess (e.g., clean, categorize, label, etc.) the user demand information collected by the smart city service platform 120 and store preprocessed user demand information into a user demand database 1213-1. The service information management model is configured to preprocess (e.g., clean, categorize, label, etc.) the service information collected by the smart city service platform 120, and store the preprocessed service information into a service information database 1213-2. In some embodiments, the service information may include initial service information, scenario information, a scenario type, a knowledge graph, or the like. The user demand information may include a historical conversation record of the user (e.g., a historical query, a historical demand information, a historical response, etc.). In some embodiments, the user service model library 1211-1 and the service information management model library 1211-2 may be disposed in a memory of the chatbot 121.

The service business operation execution module 1212 is configured to retrieve the user service model from the user service model library 1211-1 and retrieve corresponding service information in the service information database 1213-2 based on the user demand information. The service business operation execution module 1212 is also configured to process the service information and generate demand service information through a retrieved user service model and send the demand service information to the smart city user platform 110, the demand service information is then received by the user. For example, the service business operation execution module 1212 may retrieve the initial service information from the service information database 1213-2 and a corresponding user service model (e.g., a target service model) from the user service model library 1211-1. After the service business operation execution module 1212 processes the initial service information using the user service model, a response is generated, and the response is sent to the smart city user platform 110, and then the response is output via the user interface.

The service database 1213 may include the user demand database 1213-1 and the service information database 1213-2. The user demand database 1213-1 is configured to store preprocessed user demand information. The service information database 1213-2 is configured to store the preprocessed service information.

The smart city management platform 130 refers to a comprehensive management platform for service information related to city services. In some embodiments, the smart city management platform 130 may include a server, a memory, a gateway, a network transmission device (e.g., a 5G network module), or the like. In some embodiments, the smart city management platform 130 may also include sensors (e.g., temperature sensors, pressure sensors, humidity sensors, etc.), surveillance cameras, input terminals (e.g., smartphones, laptops, desktop computers, tablets, etc.), or the like.

In some embodiments, the smart city management platform 130 may be configured to collect the initial service information, the scenario information, or the like. For example, for a city service scenario, the initial service information may include a real-time load value of a power grid, a heat map of traffic flow, a PM2.5 concentration, a noise decibel, a gas price, a gas maintenance schedule, a gas pipeline status, etc. As another example, for an industrial service scenario, the initial service information may include supply chain information, a device (e.g., a press machine) state, an operating parameter, or the like.

The service cloud 140 refers to a collection of cloud resources based on cloud computing. The service cloud 140 may include Infrastructure as a Service (IaaS), Platform as a Service (PaaS), and Software as a Service (Saas), or the like. Functions of the service cloud 140 are similar to functions of the smart city management platform 130. More descriptions regarding the service cloud 140 may be found in the smart city management platform 130 and its related descriptions.

In some embodiments, the smart city service platform 120 may interact bi-directionally with the smart city user platform 110, the smart city management platform 130, and the service cloud 140, respectively. For example, the smart city user platform 110 may upload various types of demand information of the user to the smart city service platform 120. In response to the smart city user platform 110 performing a relevant operation such as a query, the smart city service platform 120 may send a response to the query to the smart city user platform 110, and the response is displayed to the user via the user interface. For example, the smart city service platform 120 may obtain the service information from the smart city management platform 130 or the service cloud 140, and various types of demand information of different users from the smart city user platform 110. The smart city service platform 120 may also send the preprocessed service information to the smart city management platform 130 or the service cloud 140.

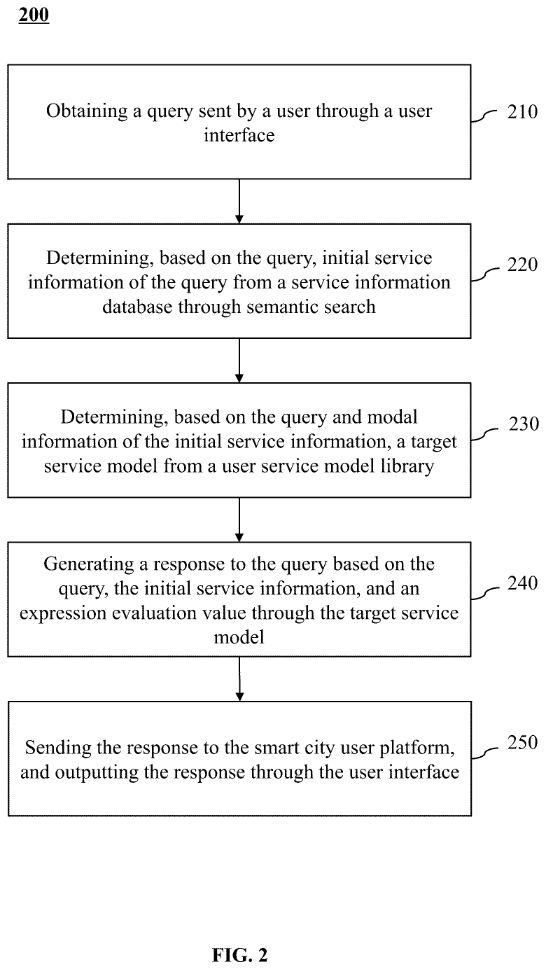

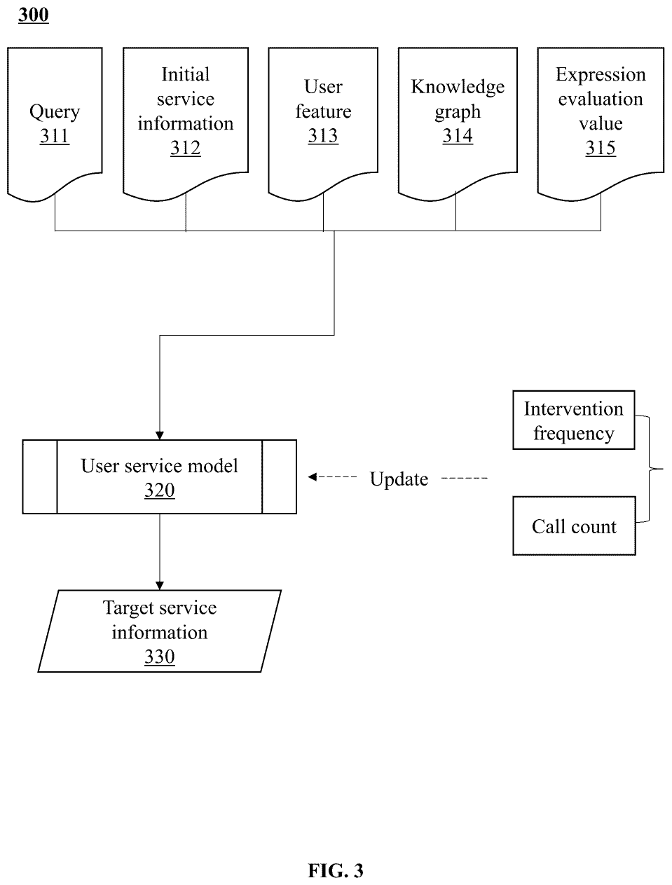

More descriptions regarding the user service model, the semantic feature, the target service model, the initial service information, the scenario information, the scenario type, and the knowledge graph may be found in FIG. 2 and FIG. 3 and their related descriptions. More descriptions regarding the historical conversation record, the query, the demand information, and the response may be found in FIGS. 2-4 and their related descriptions.

Embodiments of the present disclosure address the problems of slow service response speed and poor accuracy for the different demands of different types of users in the smart city. The user demand can be extracted by deploying a dual service model of a user service model and a service information management model on the smart city service platform 120, and the preprocessed service information can be quickly extracted from the service information database 1213-2 to generate the demand service information. Meanwhile, the user service model and the service information management model in the embodiments of the present disclosure are capable of self-learning and training based on user feedback, and the service response speed and accuracy can be effectively improved.

FIG. 2 is a flowchart illustrating an exemplary process for determining a response according to some embodiments of the present disclosure. As shown in FIG. 2, a process 200 includes the following operations. In some embodiments, the process 200 may be performed by the chatbot 121.

In 210, a query sent by a user may be obtained through a user interface.

The user interface refers to an operation interface through which the user interacts with the smart city user platform 110. In some embodiments, the user interface may include visual elements (e.g., icons, buttons), interaction manners (e.g., taps, swipes, voice commands), feedback mechanisms (e.g., alert messages, animation effects, voice playback), or the like.

The query refers to an instruction submitted by the user to the smart city user platform 110 and/or the smart city service platform 120 through the user interface. In some embodiments, the query may include a keyword entered by the user, an image uploaded by the user, a voice command of the user, etc. For example, the query may be “preventive maintenance program for the press machine”. In some embodiments, the query may include natural language, code language, or the like. For example, the query may include Chinese, English, Japanese, Basic, Pascal, Object Pascal, C, or the like.

In 220, initial service information of the query may be determined from a service information database based on the query through semantic search.

The initial service information refers to the service information stored in the service information database. In some embodiments, the initial service information may be generic information and/or data that is not customized based on the query. In some embodiments, the initial service information may include service scenario, hardware control, etc. For example, if the initial service information is a city service scenario, the initial service information may include the real-time load value of the power grid, the heat map of traffic flow at a traffic intersection, the gas maintenance schedule, or the like. For example, if the initial service information is the hardware control, the initial service information may be a power level of the hardware.

In some embodiments, the chatbot 121 is further configured to preprocess and store the service information collected by the smart city management platform 130 to construct the service information database. The preprocessing may include a format unification, a data cleaning and filtering, a standardized conversion, the classification and the labeling, or the like. More descriptions regarding the smart city management platform 130 may be found in FIG. 1 and its related descriptions.

The embodiments of the present disclosure preprocess and store the service information collected by the smart city management platform 130, and construct the service information database, thereby ensuring the standardization and usability of the data. By preprocessing the service information (e.g., cleaning, classification, labeling, etc.), the accuracy and integrity of the data are improved to provide a reliable basis for the subsequent query processing, and the data collection of a plurality of the service scenarios (e.g., power grids, gas pipelines, transportation, etc.) is supported, which provides data support for the functional expansion of the chatbot 121.

In some embodiments, the chatbot 121 may determine the initial service information of the query from the service information database based on the query through the semantic search. For example, the chatbot 121 may convert the query into textual information, and based on the textual information, the chatbot 121 may perform a semantic extraction via a semantic extraction algorithm and/or model to obtain the semantic features (e.g., combination rules of words, sentences, or phrases, context, etc.). The semantic extraction algorithm and/or model may include Bag-of-Words (BoW) model, Term Frequency-Inverse Document Frequency (TF-IDF) algorithm, Bidirectional Encoder Representations from Transformers (BERT) model, Word2Vec, etc. The chatbot 121 may obtain the initial service information by performing a semantic search in the service information database based on the semantic feature.

In 230, a target service model may be determined from a user service model library based on the query and modal information of the initial service information.

The modal information of the initial service information refers to a data type, the amount of data, or the like., of the initial service information. In some embodiments, the data type of the initial service information may include text, voice, video, images, etc. In some embodiments, the chatbot 121 may obtain the modal information of the initial service information from the service information database.

The target service model refers to the user service model selected and/or determined by the chatbot 121 from the user service model library. The target service model is configured to optimize the query and the initial service information to generate target service information. The target service information refers to customized information generated by the chatbot 121 through analyzing and/or optimizing the initial service information based on the query through the target service model. That is, the target service information is the customized initial service information. Compared with the initial service information, the target service information is more suitable for and/or matches the query sent by the user.

In some embodiments, the chatbot 121 may determine the target service model from the user service model library based on the query and the modal information of the initial service information through the semantic search. For example, the chatbot 121 may convert the query and the modal information of the initial service information into semantic vectors, and based on the semantic vectors, the chatbot 121 may perform the semantic extraction via the semantic extraction algorithm and/or model to obtain the semantic features. The chatbot 121 may perform the semantic search in the user service model library based on the semantic feature, match search results of the semantic search with the user service model in the user service model library, and identify the user service model with the highest semantic similarity as the target service model. More descriptions regarding the user service model may be found in FIG. 3 and its related descriptions.

In some embodiments, the chatbot 121 is further configured to obtain an interaction trajectory and the historical conversation record of the user on the user interface; determine an emotional feature of the user based on the interaction trajectory and the historical conversation record; and determine the target service model from the user service model library based on the emotional feature, the query, and the modal information of the initial service information.

The interaction trajectory refers to an operation trajectory of the user on the user interface. In some embodiments, the interaction trajectory may be a sequence of actions performed by the user during an interaction with the user interface. For example, the interaction trajectory may include user taps, swipes, inputs (text, voice, and video), gestures (zooming, rotating), page switching, scrolling, or the like. As another example, the interaction trajectory may include a timestamp for each action in the sequence of actions. The timestamp of each action is used to indicate an interaction frequency and an interaction interval of the user. As another example, the interaction trajectory may include a movement path, a click position, or the like of a mouse or a user's finger on the user interface.

The historical conversation record refers to historical conversation data generated during an interaction between the user and the chatbot 121. In some embodiments, the historical conversation record may include the query sent by the user and a corresponding response from the chatbot 121, an operation result, a conversation state, etc. For example, the historical conversation record may include a user ID or an anonymous identifier, an ID or a name of the chatbot, a timestamp of each query, a timestamp of each response, a query content (e.g., text, voice, image, video, etc.), a response content (e.g., a reply text, an operation instruction, a link, multimedia content, etc.), a conversation stage (e.g., a welcome message, a question and answer, a task execution), the conversation state (e.g., a conversation topic, an unfinished task), a conversation result (success or failure), a user feedback (e.g., satisfaction score), an error code, the query demand information, etc. More descriptions regarding the query demand information may be found in subsequent content and its related descriptions.

In some embodiments, the chatbot 121 may obtain the interaction trajectory of the user on the user interface through the smart city user platform 110 and obtain the historical conversation record through the user demand database in the service database.

The emotional feature refers to an emotional state and a psychological tendency of the user during the interaction with the chatbot 121. For example, the emotional feature may include anxiety, disappointment, satisfaction, confusion, impatience, or the like. In some embodiments, the emotional feature refers to an anxiety level of the user.

In some embodiments, the chatbot 121 may determine the emotional feature of the user based on the interaction trajectory and the historical conversation record. For example, the chatbot 121 may obtain an operation frequency of the user on the user interface based on the interaction trajectory and determine the emotional feature of the user based on the operation frequency and a historical user feedback (e.g., a historical satisfaction score) in the historical conversation record. Exemplarily, if a click frequency of the user exceeds an emotional threshold, this indicates that the user is at a high anxiety level and is dissatisfied with a current service and/or response. The emotional threshold may be positively correlated with the historical satisfaction score, that is, the higher the historical satisfaction score, the higher the emotional threshold. As another example, if the historical conversation record shows that the user sends the query in a high frequency, it indicates that the user is in the high anxiety level.

In some embodiments, the chatbot 121 may determine the target service model from the user service model library based on the emotional feature, the query, and the modal information of the initial service information. The chatbot 121 may obtain the semantic feature based on the query and construct a first feature vector based on the emotional feature, the semantic feature, and the modal information of the initial service information. The chatbot 121 may retrieve in a first vector database based on the first feature vector to obtain an identifier of the user service model, retrieve the user service model with a same identifier from the user service model library based on the identifier of the user service model, and then determine a retrieved user service model as the target service model.

A vector database refers to a database for storing, indexing, and querying vectors. The vector database enables a fast similarity query for large numbers of vectors and other vector management. More descriptions regarding obtaining the semantic feature based on the query may be found in step 220 and its related descriptions.

In some embodiments, the service business operation execution module may obtain a reference emotional feature, reference semantic feature, and reference modal information based on the historical conversation record and construct a plurality of first reference vectors based on the reference emotional feature, the reference semantic feature, and the reference modal information. Each first reference vector has a corresponding reference service model identifier.

In some embodiments, the service business operation execution module may mark the historical conversation record in the historical conversation records that has not received a negative feedback as a successful conversation record, extract the reference emotional feature, the reference semantic feature, and the reference modal information corresponding to the successful conversation record to construct the first reference vector, and determine the identifier of the user service model used for the successful conversation record as a reference service model identifier of the first reference vector. The service business operation execution module may store the plurality of first reference vectors and corresponding reference service model identifiers into the first vector database (e.g., Milvus, Faiss). More descriptions regarding the negative feedback may be found in subsequent content and its related descriptions.

In some embodiments, the first vector database may be updated periodically. For example, the service business operation execution module may update the first vector database based on a historical conversation record from a previous update cycle. An update cycle may be set based on experiences or set by the system.

The embodiments of the present disclosure determine the emotional feature of the user based on the interaction trajectory of the user on the user interface and the historical conversation record, thereby enabling the chatbot 121 to dynamically perceive emotional changes of the user, adjusting the service mode and the service strategy, and providing a more humanized interaction experience. Meanwhile, the embodiments of the present disclosure select the corresponding target service model based on the emotional feature, the semantic feature, and the modal information of the initial service information, thereby improving accuracy of the response of the chatbot 121 and user satisfaction and providing the user with a more efficient and convenient query service experience.

In some embodiments, the chatbot 121 is further configured to obtain the query demand information based on the query and the historical conversation record; and determine the target service model from the user service model library based on the emotional feature, the query demand information, the modal information of the initial service information, and scenario information.

The query demand information refers to demand information contained in the query sent by the user. In some embodiments, the query demand information may include a demand field and a query target. In some embodiments, the demand field refers to an industry field to which the demand information relates, for example, the demand field may be an electric power industry, a gas industry, a transportation industry, a manufacturing industry, or the like. In some embodiments, the query target may be determined based on the industry field and the service scenario. For example, for a city service scenario in the power industry, the query target may be a grid load in a region within a certain time period. As another example, for an industrial service scenario in the manufacturing industry, the query target may be work state data of an industrial device within a certain time period.

In some embodiments, the chatbot 121 may determine the query demand information by clustering based on the query. A clustering center of the clustering may be determined based on the historical conversation record. For example, the chatbot 121 may convert the query to the textual information and perform cleaning, word segmentation, and standardization on the textual information. The chatbot 121 may convert processed textual information into semantic feature vectors by the semantic extraction model. The semantic extraction algorithm and/or model may include a BERT model, a Robustly Optimized BERT Pretraining Approach (RoBERTa) model, or the like.

In some embodiments, the service business operation execution module may predefine a plurality of clustering centers based on the historical conversation record. For example, the service business operation execution module may extract the query target (e.g., gas pipeline monitoring, traffic flow analysis, environmental monitoring) and the semantic feature vectors with similar query targets based on the historical conversation record, and determine a mean value or a weighted average value of the semantic feature vectors with similar query targets as a clustering center of the query target. The service business operation execution module may determine the query target as a main label of the cluster center.

In some embodiments, the main label of the clustering center may also include sublabels. For example, the main label of the clustering center is “gas pipeline monitoring”, and the sublabels of the main label may include “gas industry”, “gas pipeline identifier”, “pressure detection”, “leakage warning”, or the like. For example, the main label of the clustering center is “traffic flow analysis”, and the sublabels of the main label may include “transportation industry”, “traffic volume”, etc.

In some embodiments, the service business operation execution module may determine the sublabels of the main label based on the historical conversation record and the user feedback. For example, if the query target (i.e., the main label) of the user in the historical conversation record is “gas pipeline monitoring”, the response of the chatbot 121 is data and/or information on “pressure detection”, and the user's feedback is “useful” and/or “helpful”, the service business operation execution module may identify “pressure detection” as a sublabel of “gas pipeline monitoring”.

In some embodiments, the service business operation execution module may determine the sublabels of the main label based on historical query demand information. The historical query demand information may include query demand information with positive feedback and query demand information with negative feedback. The positive feedback may be a positive evaluation by the user on the response provided by the chatbot 121, such as clicking “helpful,” or a satisfaction score being greater than a score threshold. Otherwise, it is the negative feedback. The score threshold may be set based on experiences or by the system. As another example, the query demand information with the negative feedback may be query demand information that requires a user intervention. Exemplarily, the user adjusts the response provided by the chatbot 121.

In some embodiments, the service business operation execution module may determine the sublabels of the main label based on query demand information with the positive feedback in the historical query demand information. For example, for the query demand information with the positive feedback, the query target (i.e., the main label) is “gas pipeline monitoring”, and corresponding query content is “gas pipeline identifier”, “pressure detection”, “leakage warning”, etc., then the service business operation execution module may determine the query content “gas pipeline identifier”, “pressure detection”, “leakage warning”, etc., as the sublabels of “gas pipeline monitoring”. In some embodiments, the sublabels of the main label may be defined through manual annotation based on experiences.

In some embodiments, the chatbot 121 may calculate a similarity (e.g., cosine similarity, Euclidean distance) between the semantic feature vectors of the query and the clustering centers, determine the clustering center that has the highest similarity, and determine the main label and the sublabels of the clustering center that has the highest similarity as the query demand information of the query.

The scenario information refers to hardware and/or software configuration information related to the service scenario. For example, for a gas service in the city service scenario, the scenario information may include configuration information related to gas usage. Exemplarily, the scenario information may include a type and model of a gas device (e.g., a gas stove), a model of a leakage alarm, the amount of gas used in terms of days or months, or the like. In some embodiments, the chatbot 121 may obtain the scenario information from the smart city management platform 130.

In some embodiments, the chatbot 121 may determine the target service model from the user service model library based on the emotional feature, the query demand information, the modal information of the initial service information, and the scenario information. For example, the chatbot 121 may construct a second feature vector based on the emotional feature, the query demand information, the modal information of the initial service information, and the scenario information. The chatbot 121 may retrieve in a second vector database based on the second feature vector to obtain the identifier of the user service model, retrieve the user service model with the same identifier from the user service model library based on the identifier of the user service model, and then determine the retrieved user service model as the target service model. A construction of the second vector database is similar to a construction of the first vector database. More descriptions may be found in the first vector database and its related description. Regarding a process of determining the target service model from the user service model library based on the second feature vector and the second feature vector database, the process is similar to that of determining the target service model from the user service model library based on the first feature vector and the first feature vector database. More descriptions may be found in the first feature vector and the first feature vector database and their related descriptions.

The embodiments of the present disclosure convert the query sent by the user into a structured semantic label by extracting the query demand information, thereby enhancing understanding of the chatbot 121 on the user intention. At the same time, the embodiments of the present disclosure can more accurately match the user demands by introducing the scenario information and the query demand information, further optimizing the selection of the target service model, and making the service more relevant to the specific scenario demands, so that the chatbot 121 no longer relies solely on the query or the initial service information, but comprehensively considers multi-dimensional information such as the historical conversation record, the emotional feature of the user, the scenario information, etc., for model matching, so that the system has a stronger context-awareness capability.

In 240, a response to the query may be generated based on the query, the initial service information, and an expression evaluation value through the target service model.

The expression evaluation value may be used to indicate a tolerance level of the user for ambiguous terms included in the response. The ambiguous terms refer to terms that are imprecise, non-deterministic, or leave room for interpretation. For example, the response provided by the chatbot 121 may include terms such as “possible”, “in most cases”, “cannot be processed temporarily”, “as soon as possible”, “under normal circumstances”, or the like.

In some embodiments, the expression evaluation value may be a quantitative value, such as a numerical value, a percentage, or the like. In some embodiments, if the expression evaluation value is higher than an expression threshold, it indicates that the user allows more ambiguous terms in the response, which is applicable to open discussions. If the expression evaluation value is lower than the expression threshold, it indicates that the user expects a precise response, which is applicable to an industry that requires a rigorous response (e.g., healthcare, law, etc.). The expression threshold may be determined based on experiences or set by the system.

In some embodiments, the expression evaluation value may be determined based on the historical conversation record. For example, the chatbot 121 may extract the historical conversation record of the user from the user demand database, determine an expression ability, a comprehension ability, or the like based on the historical conversation record, and quantify the expression ability, the comprehension ability, or the like based by the expression evaluation value.

In some embodiments, the chatbot 121 is further configured to determine a cognitive feature of the user based on the historical conversation record; and determine the expression evaluation value based on the cognitive feature, a user feature, and the emotional feature.

The cognitive feature refers to a manner in which the user receives, understands, and processes responses. In some embodiments, the cognitive feature may include a vocabulary richness, an expression clarity, an ability to ask consecutive questions, an ability to correct errors, or the like of the user when interacting with the chatbot 121.

In some embodiments, the chatbot 121 may determine the cognitive feature of the user based on the historical conversation record of the user. For example, data cleaning is performed on the historical conversation record of the user, and statistics are compiled on metrics such as a total vocabulary size and a proportion of different types of vocabulary (e.g., nouns, verbs, professional terms) of the user, or the like. The data cleansing may include removing irrelevant information (e.g., system prompts, formatting symbols), dealing with textual noise (e.g., spelling errors, emoticons), performing word segmentation and standardization (e.g., unifying case, converting synonyms), or the like.

The chatbot 121 may use a Natural Language Processing (NLP) model to determine whether a question of the user is accurate and analyze a proportion of questions identified by the chatbot 121 as “unintelligible” or requiring clarification. The chatbot 121 may use a Latent Dirichlet Allocation (LDA) model to identify whether a plurality of rounds of conversations revolve around a same topic, calculate a semantic similarity of neighboring questions, count an average chain length (e.g., how many rounds of conversations elapsed from the time when the query was sent to the end of the conversations) of the questions of the user over a time period, and determine an ability of the user to ask consecutive questions based on the average chain length of the questions. The chatbot 121 may also count a correction frequency that the user initiates to correct the question and/or the response and determine an error correction capability based on the correction frequency that the user initiates to correct the question and/or the response.

The user feature refers to information related to the user. In some embodiments, the user feature may include a user age, an industry in which the user is engaged, an occupation, an educational background, or the like. In some embodiments, the chatbot 121 may obtain the user feature through the smart city user platform 110.

In some embodiments, the chatbot 121 may determine the expression evaluation value based on the cognitive feature, the user feature, and the emotional feature. For example, the chatbot 121 may determine an initial expression evaluation value by querying a first preset table based on the user feature and the emotional feature.

The first preset table includes a correspondence between the user feature, the emotional feature, and the initial expression evaluation value, for example, {index 1 (the user feature) and index 2 (the emotional feature)->a query result (the initial expression evaluation value)}. The initial expression evaluation value may be a preset value, for example, the initial expression evaluation value of an elderly person (e.g., age greater than 60 years old) may be set to be lower than the expression threshold and/or may be set to be lower than the expression threshold when the emotional feature is anxiety, disappointment, or impatience. The first preset table may be constructed based on experiences.

In some embodiments, the chatbot 121 may adjust the initial expression evaluation value based on the cognitive feature and determine an adjusted initial expression evaluation value as the expression evaluation value. For example, if the vocabulary richness of the user is high (e.g., above a preset richness threshold), the initial expression evaluation value is increased.

Exemplarily, the vocabulary richness of the user may be positively correlated with a ratio of the industry terms (e.g., pressure sensors, PM2.5, etc.) to the total vocabulary. That is, the higher the ratio of the industry terms, the higher the vocabulary richness of the user. As another example, the higher the ability of the user to ask consecutive questions (e.g., the average chain length of the questions is greater than a preset chain length), the higher the initial expression evaluation value. In some embodiments, the chatbot 121 may set a preset adjustment amplitude of the initial expression evaluation value. For example, the chatbot 121 may set the preset adjustment amplitude to ±10%.

In some embodiments, the chatbot 121 may determine a mean value of historical vocabulary richness and a mean value of historical expression clarity based on the historical conversation record and determine the mean value of the historical vocabulary richness and the mean value of the historical clarity of expression as the vocabulary richness and the expression clarity of the user.

The cognitive feature of the user may directly affect a language expression ability and an understanding ability of the user. In the embodiments of the present disclosure, the expression evaluation value comprehensively considers the cognitive feature, the user feature, and the emotional feature of the user. Compared the expression evaluation value with a single feature (e.g., age), it can more comprehensively reflect a cognitive ability of the user. The embodiments of the present disclosure analyze the cognitive feature of the user based on the historical conversation record of the user, and dynamically determine the expression evaluation value by combining the user feature and the emotional feature, which can enable the chatbot 121 to better adapt to expression habits and comprehension abilities of different users, thereby improving the accuracy of interaction and user experience, and ensuring that the system can provide efficient and accurate services in different scenarios.

In some embodiments, the chatbot 121 is further configured to determine the expression evaluation value based on the historical conversation record, the cognitive feature, the user feature, the emotional feature, and the query through the fuzzy processing model.

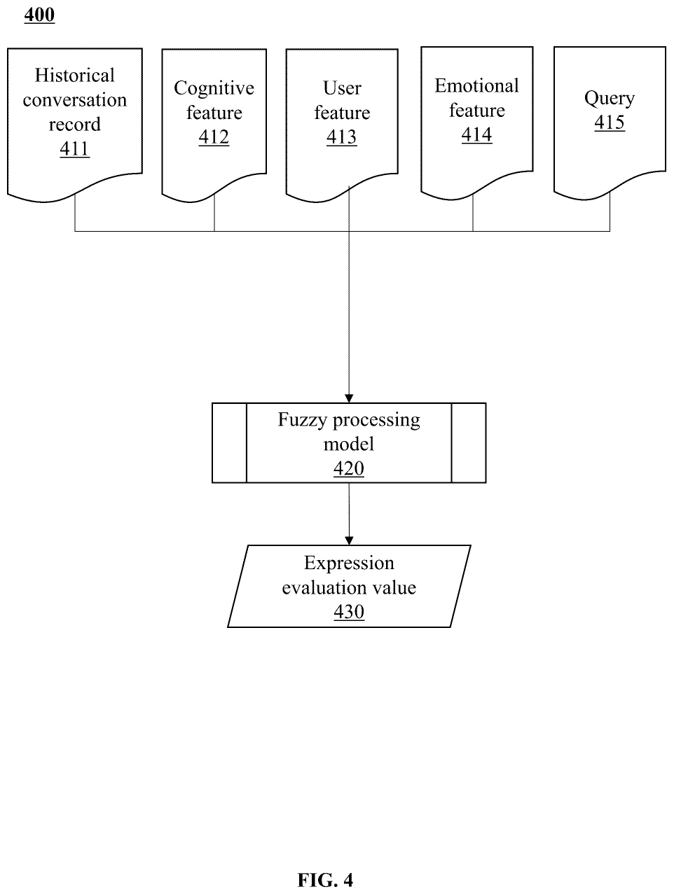

More descriptions regarding determining the expression evaluation value via the fuzzy processing model may be found in FIG. 4 and its related descriptions.

The response to the query refers to a response made by the chatbot 121 to the query. In some embodiments, the response to the query may be used to answer a question, guide a conversation, perform a task, or the like. In some embodiments, the response to the query may be the target service information. More descriptions regarding the target service information, see step 230 and its related description.

In some embodiments, the chatbot 121 may generate a response to the query based on the query, the initial service information, and the expression evaluation value via the target service model. More descriptions regarding the query may be found in step 210 and its related descriptions. More descriptions regarding the initial service information may be found in step 220 and its related descriptions. More descriptions regarding the target service model may be found in step 230 and its related descriptions.

More descriptions regarding generating the response to the query via the target service model may be found in FIG. 3 and its related descriptions.

In some embodiments, the response further includes a hardware service response, the hardware service response includes a to-be-adjusted hardware and an adjustment parameter. In some embodiments, the chatbot 121 is further configured to: in response to the response being the hardware service response, send the adjustment parameter to the smart city management platform 130 to set an operating parameter of the to-be-adjusted hardware.

The hardware service response refers to a response from the chatbot 121 to the query when the query includes hardware information (e.g., hardware-related terms). In some embodiments, the hardware service response may include troubleshooting and solutions, installation and setup instructions, parameter information of a hardware device, or the like. In some embodiments, the hardware service response may include the to-be-adjusted hardware and the adjustment parameter. The to-be-adjusted hardware refers to a hardware included in the query (e.g., the gas stove, the press machine).

In some embodiments, the user may send the query including the to-be-adjusted hardware to the smart city user platform 110 via the user interface. The smart city user platform 110 may send the query including the to-be-adjusted hardware to the chatbot 121. In response to the response being the hardware service response, the chatbot 121 may send the to-be-adjusted hardware and/or the adjustment parameter to the smart city management platform 130. After the smart city management platform 130 receives the to-be-adjusted hardware and/or the adjustment parameter, the smart city management platform 130 sets the operating parameter (e.g., an operating power, an operating state, etc.) of the to-be-adjusted hardware based on the adjustment parameter.

For example, for the industrial service scenario, the user sends a query as “why does the press machine make abnormal noise”. The chatbot 121 determines that a reason for the abnormal noise is a lack of lubrication, and it is necessary to suspend work of the press machine and oil the press machine, then the chatbot 121 may send “adjust operating power of the press machine to 0” to the smart city management platform 130, and the smart city management platform 130 suspends the work of the press machine.

In some embodiments, in response to adjustments and/or operations of the hardware that require confirmation by the user, before sending the to-be-adjusted hardware and/or the adjustment parameter to the smart city management platform 130, the chatbot 121 may send the to-be-adjusted hardware and/or the adjustment parameter to the smart city user platform 110. The smart city user platform 110 may display the to-be-adjusted hardware and/or the adjustment parameter to the user via the user interface. After the user confirms or modifies the adjustment parameter, the smart city user platform 110 executes a process of configuring the operating parameter of the to-be-adjusted hardware based on the adjustment parameter.

In response to the response being the hardware service response, the embodiments of the present disclosure can send the to-be-adjusted hardware and/or the adjustment parameter to the smart city management platform 130, thereby realizing an intelligent control of the hardware device. Meanwhile, it can automatically adjust the operating parameter of the hardware device (e.g., the operating power, the operation state, etc.) based on the query and a determination of the chatbot 121, which can improve a regulation efficiency.

In 250, the response may be sent to the smart city user platform 110, and the response may be output through the user interface.

In some embodiments, the response may be displayed to the user via the user interface in a form of a plain text. For example, the response may be displayed to the user in the form of a step, a list, or a comparison table. In some embodiments, the response may be embedded with rich media elements such as images, links, buttons, videos, or the like, the response may be displayed to the user through the user interface. In some embodiments, the response may be displayed to the user via the user interface in a multimodal form. For example, the response may be displayed to the user in the form of text, voice, and/or video, or the like, simultaneously.

In the embodiments of the present disclosure, the chatbot 121 is capable of understanding the query of the user and generating accurate response by natural language processing technology, which improves the intelligence level of the user interaction; and the initial service information is quickly extracted from the service information database through the semantic search and the user service model and a response is generated, thereby improving the service response efficiency. Meanwhile, the embodiments of the present disclosure select a suitable target service model based on the query and the modal information of the initial service information to generate the customized response, which satisfies the personalized demands of the user; and through the introduction of the expression evaluation value, it enables the chatbot 121 to adapt to the expression habits and comprehension abilities of different users, enhancing the user experiences.

FIG. 3 is a schematic diagram of a user service model according to some embodiments of the present disclosure.

In some embodiments, inputs of the user service model 320 may include a query 311, an initial service information 312, a user feature 313, a knowledge graph 314, and an expression evaluation value 315. An output of the user service model 320 is target service information 330 (i.e., the response).

In some embodiments, the knowledge graph 314 may be obtained through industry databases (e.g., gas codes, hardware device operating manuals, etc.). The knowledge graph 314 includes nodes and edges, and the knowledge graph may be used to characterize structured knowledge of the industry. The nodes of the knowledge graph 314 are entities within the industry, and the edges are associations and/or relationships between the entities. For example, for the gas service in the city service scenario, the nodes of the knowledge graph 314 may include gas meters, gas pipelines, pressure regulator stations, valves, etc. Node features may include reading ranges of the gas meters, pressure ranges of the gas pipelines, pressure regulating ranges of the pressure regulator stations, openings of the valves, or the like. The edges of the knowledge graph 314 may include connections between the gas meters, connections between the gas pipelines, connections between the pressure regulator stations and the gas pipelines, connections between the valves and the gas pipelines, or the like. Edge features may include a gas supply zone, a management unit, or a user that the gas meter belongs to, an upstream and downstream relationship of the gas pipelines, the gas pipeline pressure controlled by the pressure regulator station, and the gas pipeline flow controlled by the valves, or the like.

More descriptions regarding the query 311, the initial service information 312, the user feature 313, the expression evaluation value 315, and the target service information 330 may be found in FIG. 2 and its related descriptions.

In some embodiments, the user service model 320 may be obtained by training based on at least one set of first training samples and their corresponding first labels. In some embodiments, the first training samples may include at least one set of sample queries, sample initial service information, sample user features, sample knowledge graphs, and sample expression evaluation value of sample users from the historical conversation record. The first labels of the first training samples may be textual information of the target service information displayed to the sample user and a modality of the target service information. The modality of the target service information may include text, voice, image, video, etc.

The first training sample may include a positive training sample and a negative training sample. For example, the positive training sample refers to a training sample that does not receive a continuation of a question and/or a query from the sample user after the end of the historical conversation. As another example, the positive training sample refers to the historical conversation record with positive feedback. The first label of the positive training sample is the textual information of the target service information and the modality of the target service information that is displayed to the sample user after the end of the historical conversation. More descriptions regarding the positive feedback may be found in FIG. 2 and its related descriptions. Also, for example, the negative training sample refers to a training sample that receives a corrected response from the sample user during a process of the historical conversation. The first label of the negative training sample is the textual information of the target service information corrected by the sample user and a modality of corrected target service information.

During training, the first training samples are input into the initial user service model, a first loss function is constructed based on the outputs of the initial user service model and the first labels, a parameter of the initial user service model is iteratively updated (e.g., by a gradient descent manner) based on the first loss function until a preset training condition is satisfied, the training is completed, the trained user service model is obtained, and the trained user service model is used as the user service model 320. The preset training condition may include, but is not limited to, a first loss function converging, a training period reaching a threshold, or the like.

In some embodiments, the user service model library includes a plurality of user service models 320. In some embodiments, the chatbot 121 is further configured to determine an intervention frequency of the plurality of user service models 320 based on historical intervention data of the plurality of user service models 320; it is known that there are two cases: the intervention frequency and a call count are less than or equal to the dynamic threshold, and the intervention frequency and the call count are greater than the dynamic threshold, and in response to an intervention frequency and the call count of at least one user service model 320 of the plurality of user service models 320 being greater than a dynamic threshold, the chatbot 121 is further configured to update the at least one user service model 320 based on the historical conversation record. The dynamic threshold is determined based on the user feature 313 and the scenario type. More descriptions regarding the user feature 313 may be found in FIG. 2 and its related descriptions.

The historical intervention data refers to data where there are adjustments and/or

corrections made by the user to the output of the user service model 320. For example, the query issued by the user is “What is the state of a press machine 3 now?”. The chatbot 121 obtains an output from the user service model 320 as “The press machine 3 is currently in a state of ‘running’ and a production progress is normal” and uses the output as the response to the query of the user. The user then submits a correction of “no, the screen of the press machine 3 is showing ‘Under Maintenance’, possibly a sensor failure”, and an adjusted output obtained by the chatbot 121 from the user service model 320 is “Thank you for your feedback! It has been confirmed that the press machine 3 is actually under maintenance, but the system is not synchronized and updated. Engineers have been notified to check the sensors and the repair is expected to complete within 30 minutes. Do you need to adjust the production plan or start a backup device? you can click the link to view the device maintenance log.”

The intervention frequency refers to a count of times that a user adjusts and/or corrects the output of the user service model 320 (i.e., the response of the chatbot 121) in a single historical conversation record. For example, during the process of a historical conversation, the user may adjust and/or correct the output of the user service model 320 multiple times until the end of the historical conversation.

In some embodiments, the chatbot 121 may obtain the historical conversation records of a user service model in different time periods from the user demand database, count the historical intervention data of the user in the historical conversation record in each time period, and determine a mean value or a weighted average value of the historical intervention data in the each time period as the intervention frequency of the user service model 320.

The dynamic threshold is used to determine whether to update the user service model 320 based on the intervention frequency of the user service model 320 and/or the call count of the service model. In some embodiments, the dynamic threshold may include an intervention threshold and/or a call threshold. The intervention threshold and the call threshold may be set artificially based on experiences or set by the system.

The scenario type refers to an industry category of the service scenario. For example, the scenario type may include an industrial service scenario, a gas service scenario, a transportation service scenario, or the like. More descriptions regarding the service scenario may be found in FIG. 2 and its related descriptions.

In some embodiments, the service business operation execution module may construct a third feature vector based on the user feature 313 and the scenario type. The service business operation execution module may obtain the dynamic threshold by searching in the third vector database based on the third feature vector.

In some embodiments, the service business operation execution module may obtain historical user data from the smart city user platform 110; obtain a reference user feature and a reference scenario type based on the historical user data; and construct a plurality of third reference vectors based on the reference user feature and the reference scenario type, and each third reference vector has a corresponding reference dynamic threshold. User data may include personal information, payment behavior records, education information, employment and occupation information, or the like.

For example, the service business operation execution module may use a clustering algorithm to classify the user into a plurality of clusters based on the historical user data and determine the clustering center of the plurality of clusters as the third reference vector. The clustering algorithm may include K-means clustering (K-means) algorithm, Density-Based Spatial Clustering of Applications with Noise (DBSCAN) algorithm, or the like.

The service business operation execution module may obtain the historical conversation record of the user in a cluster from the user demand database based on the historical user data, and statistically determine a mean value of a historical intervention frequency and a mean value of a historical call count based on the historical conversation record of the user in the cluster. The service business operation execution module may adjust the mean value of the historical intervention frequency and the mean value of the historical call count based on the preset adjustment amplitude and determine an adjusted mean value of the historical intervention frequency and an adjusted mean value of the historical call count as a reference dynamic threshold for the cluster. The preset adjustment amplitude may be set based on experiences or set by the system. In some embodiments, the reference dynamic threshold for clustering may be obtained by lowering the mean value of the historical intervention frequency and/or the mean value of the historical call count by the preset adjustment amplitude. For example, the reference dynamic threshold for cluster is a difference between the mean value of the historical intervention frequency and the preset adjustment amplitude and/or a difference between the mean value of the historical call count and the preset adjustment amplitude.

Exemplarily, assuming that the cluster is: (elderly user, gas service scenario), the mean value of the historical intervention frequency is 6 times/week, the mean value of the historical call count is 7 times/week, and the preset adjustment amplitude of the mean value of the historical intervention frequency and the mean value of the historical call count is 1, the service business operation execution module may determine the reference dynamic threshold for the cluster as: (the intervention threshold is 5 times/week, the call threshold is 6 times/week). The service business operation execution module may store the plurality of third reference vectors and the corresponding reference dynamic threshold into the third vector database (e.g., Milvus, Faiss).

In some embodiments, the service business operation execution module may dynamically adjust the intervention threshold during a chat between the user and the chatbot 121. For example, the intervention threshold may be positively correlated with the satisfaction score. That is, the higher the satisfaction score, the higher the intervention threshold, the fewer update times of the user service model 320. More descriptions regarding the satisfaction score may be found in FIG. 2 and its related descriptions.

In some embodiments, the chatbot 121 is further configured to determine the dynamic threshold based on the user feature 313, the scenario type, and the scenario information.

In some embodiments, the service business operation execution module may construct a fourth feature vector based on the user feature 313, the scenario type, and the scenario information. The service business operation execution module may obtain the dynamic threshold by retrieving in a fourth vector database based on the fourth feature vector. More descriptions regarding the scenario information may be found in FIG. 2 and its related descriptions. A construction of the fourth feature vector and the fourth vector database is similar to a construction of the third feature vector and the third vector database. More descriptions regarding the fourth feature vector and the fourth vector database may be found in the descriptions regarding the third feature vector and the third vector database.

The embodiments of the present disclosure significantly improve the demand identification accuracy and service adaptability of the smart city service platform 120 by integrating hardware/software configuration data (e.g., a gas device model, a gas usage, etc.). Meanwhile, the embodiments of the present disclosure support multi-dimensional user grouping and model training optimization, thereby reducing the misjudgment rate and shortening the service response time and realizing the upgrade from “generalization” to “scenario-based” precise service.

In some embodiments, in response to the intervention frequency of the user service model being greater than the intervention threshold and the call count of the user service model 320 being greater than the call threshold, the chatbot 121 may determine the user service model 320 as a to-be-updated user service model and send the to-be-updated user service model to the service business operation execution module. The service business operation execution module obtains the historical conversation record from the last update time point of the user service model to a current time point from the user demand database and generates the first training samples and first labels of the user service model 320, and subsequently trains and updates the user service model 320.

In some embodiments, for the user service model 320 that is updated for the first time, the service business operation execution module may obtain the historical conversation record within a preset historical time period from the user demand database, and generate the first training samples and the first labels of the user service model 320 based on an obtained historical conversation record, and then train and update the user service model 320. The preset history time period may be set manually based on experiences or set by the system.

In some embodiments, the service business operation execution module may determine the scenario type that the user is concerned about based on the historical intervention data, obtain the service information of the scenario type that the user is concerned about from the smart city management platform 130 and/or the service cloud 140, and train and update the user service model 320 after generating the first samples and the first labels based on the service information of the scenario type that the user is concerned about.

In some embodiments, the chatbot 121 may determine the to-be-updated user service model based on the intervention frequency and the satisfaction score of the user service model 320. For example, in response to the intervention frequency of the user service model 320 being greater than the intervention threshold and the satisfaction score of the user on the response provided by the user service model 320 being less than the call threshold, the chatbot 121 may determine the user service model 320 as the to-be-updated user service model, and send the to-be-updated user service model to the service business operation execution module to perform an update of the user service model 320. More descriptions regarding the satisfaction score and the score threshold may be found in FIG. 2 and its related descriptions.

The embodiments of the present disclosure calculate the intervention frequency based on historical intervention data of the user service model 320 in the user service model library and update the user service model 320 whose intervention frequency is higher than the dynamic threshold, this enables timely identification and repair of underperforming user service model 320, ensures the accuracy and utility of the output results, and ensures that the user service model 320 can be adapted to changes in user demands. Meanwhile, the embodiments of the present disclosure update the user service model 320 whose call count higher than the call threshold and whose intervention frequency higher than the intervention threshold, which can avoid the waste of resources and improve the efficiency of the system update. The embodiments of the present disclosure generate training samples and labels based on historical conversation record, perform intensive updates on the user service model 320, and conduct the key optimization for the scenario type that the user focus on, which can enhance the accuracy and practicality of the user service model 320.

FIG. 4 is a schematic diagram illustrating a fuzzy processing model according to some embodiments of the present disclosure.

In some embodiments, inputs of the fuzzy processing model 420 may include a historical conversation record 411, a cognitive feature 412, a user feature 413, an emotional feature 414, and a query 415, and an output of the fuzzy processing model 420 may include an expression evaluation value 430. In some embodiments, the fuzzy processing model 420 may be a Long Short-Term Memory (LSTM) model.

In some embodiments, the fuzzy processing model 420 may be obtained by training based on at least one set of the second training samples and the second labels of the second training samples. In some embodiments, the second training samples may include at least one set of the sample conversation records, the sample cognitive features, the sample user features, the sample emotional features, and the sample queries corresponding to historical data (e.g., historical service information, historical user demand data) of the sample user. The second labels of the second training samples may be the expression evaluation value of the sample user.

For example, the second training sample may be a training sample that does not receive a continuation of question and/or query from the sample user after the end of the sample conversation record for the sample user. As another example, the second training sample may be a training sample with the positive feedback. The second label may be the expression evaluation value of the sample user who does not ask further questions and/or make further query, or the expression evaluation value of the sample user who provides the positive feedback. The second label may include the expression evaluation value of the sample user that is higher than the expression threshold and the expression evaluation value of the sample user that is lower than the expression threshold. More descriptions regarding the expression threshold may be found in FIG. 2 and its related descriptions.

In some embodiments, the service business operation execution module may obtain the historical data (e.g., historical service information, historical user demand data) from the user demand database and the service information database. More descriptions regarding the historical conversation record 411, the cognitive feature 412, the user feature 413, the emotional feature 414, the query 415, the expression evaluation value 430, and the positive feedback may be found in FIG. 2 and its related descriptions.

A training of the fuzzy processing model 420 is similar to the training of the user service model 320. More descriptions regarding the training of the fuzzy processing model 420 may be found in FIG. 3 and its related descriptions.

In the embodiments of the present disclosure, the fuzzy processing model 420 is capable of dynamically adjusting the expression evaluation value according to the historical conversation record and the current query of the user, thereby further enhancing the interaction effect of the system. Embodiments of the present disclosure use the fuzzy processing model such as the LSTM to generate the expression evaluation value 430 based on the historical conversation record 411, the cognitive feature 412, the user feature 413, the emotional feature 414, and the query 415, thereby improving the intelligence level of the system. The embodiments of the present disclosure generate the training samples and the labels through the historical data (e.g., the historical service information, the historical user demand data) to train the fuzzy processing model 420, thereby ensuring the accuracy and adaptability of the model.

The basic concepts have been described above, and it is apparent to a person skilled in the art that the above detailed disclosure serves only as an example and does not constitute a limitation of the present disclosure. While not expressly stated herein, a person skilled in the art may make various modifications, improvements, and amendments to the present disclosure. Those types of modifications, improvements, and amendments are suggested in the present disclosure, so those types of modifications, improvements, and amendments remain within the spirit and scope of the exemplary embodiments of the present disclosure.

What is claimed is:

1. A smart city service system based on an Internet of Things large model, comprising a smart city user platform and a smart city service platform, wherein the smart city service platform includes a chatbot, and the chatbot is configured to:
obtain a query sent by a user through a user interface;
determine, based on the query, initial service information of the query from a service information database through semantic search, wherein the service information database is disposed in a memory of the chatbot;
determine, based on the query and modal information of the initial service information, a target service model from a user service model library, wherein the target service model is stored in the memory of the chatbot;
generate a response to the query based on the query, the initial service information, and an expression evaluation value through the target service model; and
send the response to the smart city user platform, and output the response through the user interface.

2. The smart city service system of claim 1, further comprising a smart city management platform, wherein the response includes a hardware service response, the hardware service response includes a to-be-adjusted hardware and an adjustment parameter, and the chatbot is further configured to:
in response to the response being the hardware service response, send the adjustment parameter to the smart city management platform to set an operating parameter of the to-be-adjusted hardware.

3. The smart city service system of claim 1, wherein the chatbot is further configured to:
obtain an interaction trajectory and a historical conversation record of the user on the user interface;
determine an emotional feature of the user based on the interaction trajectory and the historical conversation record; and
determine the target service model from the user service model library based on the emotional feature, the query, and the modal information of the initial service information.

4. The smart city service system of claim 3, wherein the chatbot is further configured to:
obtain query demand information based on the query and the historical conversation record; and
determine the target service model from the user service model library based on the emotional feature, the query demand information, the modal information of the initial service information, and scenario information.

5. The smart city service system of claim 3, wherein the expression evaluation value is determined by a process including:
determining a cognitive feature of the user based on the historical conversation record; and
determining the expression evaluation value based on the cognitive feature, a user feature, and the emotional feature.

6. The smart city service system of claim 5, wherein the chatbot is further configured to:
determine the expression evaluation value based on the historical conversation record, the cognitive feature, the user feature, the emotional feature, and the query by a fuzzy processing model.

7. The smart city service system of claim 1, wherein the user service model library includes a plurality of user service models, and the chatbot is further configured to:
determine an intervention frequency of the plurality of user service models based on historical intervention data of the plurality of user service models; and
in response to an intervention frequency and a call count of at least one user service model of the plurality of user service models being greater than a dynamic threshold, update the at least one user service model based on a historical conversation record, wherein the dynamic threshold is determined based on a user feature and a scenario type.

8. The smart city service system of claim 7, wherein the chatbot is further configured to:
determine the dynamic threshold based on the user feature, the scenario type, and scenario information.

9. The smart city service system of claim 1, further comprising a smart city management platform, wherein the chatbot is further configured to:
preprocess and store service information collected by the smart city management platform to construct the service information database.

10. A smart city service method based on an Internet of Things large model, comprising:
obtaining a query sent by a user through a user interface;
determining, based on the query, initial service information of the query from a service information database by semantic search, wherein the service information database is disposed in a memory of a chatbot;
determining, based on the query and modal information of the initial service information, a target service model from a user service model library, wherein the target service model is stored within the memory of the chatbot;
generating a response to the query based on the query, the initial service information, and an expression evaluation value by the target service model; and
sending the response to a smart city user platform, and outputting the response through the user interface.

11. The smart city service method of claim 10, wherein the response includes a hardware service response, the hardware service response includes a to-be-adjusted hardware and an adjustment parameter, and the method further comprises:
in response to the response being the hardware service response, sending the adjustment parameter to a smart city management platform to set an operating parameter of the to-be-adjusted hardware.

12. The smart city service method of claim 10, wherein the determining a target service model from a user service model library based on the query and the modal information of the initial service information includes:
obtaining an interaction trajectory and a historical conversation record of the user on the user interface;
determining an emotional feature of the user based on the interaction trajectory and the historical conversation record; and
determining the target service model from the user service model library based on the emotional feature, the query, and the modal information of the initial service information.

13. The smart city service method of claim 12, further comprising:
obtaining query demand information based on the query and the historical conversation record; and
determining the target service model from the user service model library based on the emotional feature, the query demand information, the modal information of the initial service information, and scenario information.

14. The smart city service method of claim 12, wherein the expression evaluation value is determined by a process including:
determining a cognitive feature of the user based on the historical conversation record; and
determining the expression evaluation value based on the cognitive feature, a user feature, and the emotional feature.

15. The smart city service method of claim 14, further comprising:
determining the expression evaluation value based on the historical conversation record, the cognitive feature, the user feature, the emotional feature, and the query through a fuzzy processing model.

16. The smart city service method of claim 10, wherein the user service model library includes a plurality of user service models, and the method further comprises:
determining an intervention frequency of the plurality of user service models based on historical intervention data of the plurality of user service models; and
in response to the intervention frequency and a call count of at least one user service model of the plurality of user service models being greater than a dynamic threshold, updating the at least one user service model based on a historical conversation record, wherein the dynamic threshold is determined based on a user feature and a scenario type.

17. The smart city service method of claim 16, further comprising:
determining the dynamic threshold based on the user feature, the scenario type, and scenario information.

18. The smart city service method of claim 10, further comprising:
pre-processing and storing service information collected by a smart city management platform to construct the service information database.

19. A non-transitory computer-readable storage medium, wherein the non-transitory computer-readable storage medium stores computer instructions, and when a computer reads the computer instructions in the non-transitory computer-readable storage medium, the computer executes a smart city service method based on an Internet of Things large model, the method comprising:
obtaining a query sent by a user through a user interface;
determining, based on the query, initial service information of the query from a service information database by semantic search, wherein the service information database is disposed in a memory of a chatbot;
determining, based on the query and modal information of the initial service information, a target service model from a user service model library, wherein the target service model is stored within the memory of the chatbot;
generating a response to the query based on the query, the initial service information, and an expression evaluation value through the target service model; and
sending the response to a smart city user platform, and outputting the response through the user interface.
